(19) United States
(12) Patent Application Publication
(10) Pub. No.: US 2008/0212439 A1
(43) Pub. Date: Sep. 4, 2008

(54) Embedded Recording and Playback Device for a Musical Instrument and Method Thereof

(75) Inventors: Yum Ho Wilbur Chan, Kowloon (HK); Tak Kwong Steve Lo, Kowloon (HK); Kwai Chin Yvonne Yu, Kowloon (HK)

Correspondence Address: INTELLECTUAL PROPERTY LAW GROUP LLP, 12 SOUTH FIRST STREET, SUITE 1205, SAN JOSE, CA, 95113, US

(73) Assignee: LEGENDARY SOUND INTERNATIONAL LTD., Road Town (VG)

(21) Appl. No.: 12/040,855

(22) Filed: Feb. 29, 2008

Related U.S. Application Data
(60) Provisional application No. 60/892,835, filed on Mar. 2, 2007.

(51) Int. Cl. G11B 31/00

(52) U.S. Cl. 369/69

(57) ABSTRACT

There is provided a recording and playback system and method thereof for musical instruments, in particular within a guitar. The system includes a device for recording and playback installed within a guitar and a memory data storage device for recording audio from the guitar, playback of audio, and transferring of audio to a computer system for playback and manipulation. A software program is used for converting the recorded audio file into a playable format for a computer system.

### CROSS-REFERENCE TO RELATED APPLICATIONS

This application claims priority to U.S. provisional patent application No. 60/892,835, filed on Mar. 2, 2007, which is incorporated herein by reference.

### BACKGROUND OF THE INVENTION

1. Field of Invention

The present invention generally relates to the field of audio recording and playback technology. More particularly, the present invention relates to methods and an apparatus for recording and playback of audio from an instrument such as a stringed instrument, and more particularly for recording and playback of audio through a device embedded within a stringed instrument, as well as a memory data storage device for recording audio from the instrument, playback of audio, and transferring of audio to a computer system for playback and manipulation.

2. Background

Currently, there are recording devices used externally from musical instruments for recording sounds and music when an instrument is played. Such devices either must be connected to a separate microphone, which takes in the audio from the musical instrument, or must come with a built-in microphone for capturing the audio. These recording devices come in varying degrees of portability. Some are too heavy or complex to be used outside of a recording studio. Others are small, but still must be transported separately from the instrument, requiring any corresponding wires and microphones to be accounted for as well. The setup and transportation of such devices can therefore be cumbersome and complicated to a musician seeking the most portable recording solution possible. Even if all of the pieces are accounted for, these devices may not provide all the functionality of recording and playing back the sounds clearly and with a high capacity of memory storage. In addition, such devices do not account for the need to easily transport a recording of the instrument sounds using a portable memory data storage device to a computer system for playback.

With an instrument such as a guitar, there is a need to have quick and convenient access to recording the guitar sounds without requiring the connection or any setup of external recording devices. Many guitar players desire to have their recordings played back in an easy and user-friendly fashion and for educational purposes in improving one's playing skills. Playback of the guitar sounds would serve as a training tool and provides the ability to learn from a recording of their own playing. In addition, the convenience of a contained device integral within the guitar would allow ease in mobility and spontaneous recording of the guitar sounds.

### SUMMARY OF THE INVENTION

Therefore, there is a need for a discrete and easy to use recording and playback system, in which the recording and playback device is integral to an instrument and compatible with an easy to transport memory data storage device.

One or more of the embodiments of the present invention provide a device for audio recording and playback, embedded within a musical instrument. One of the principal objects of the present invention is to provide a method of recording and playing back audio from an instrument, in a manner that maximizes portability, convenience, simplicity of use, clarity and fidelity of sound.

It is also an objective of the present invention to provide a method in which the recording and playback device is made integral to the instrument itself, and is compatible with an easy to transport memory data storage device.

It is a further object of the present invention to accommodate existing memory data storage devices to be used in an instrument.

It is a further object of the present invention to provide for an educational tool allowing a user to playback a pre-recorded performance and also play over such a recording and/or along with recordings of other artists.

In another embodiment of the present invention, the device includes a line in jack for plugging a microphone, allowing for recording of additional sounds such as voice/singing and further allowing for playback of the recorded additional sounds along with the instrument audio.

It is a further object of the present invention to allow a user to play the audio file from the instrument and play the audio file on any computer.

The above objects are met in an embodiment of the present invention, in which there is provided a guitar comprising an integrated recording and playback device; a user friendly and discrete interface; and having a compatibility with a flash memory device or other similar memory storage devices.

In another embodiment of the present invention there is a recording and playback device which incorporates a high compression algorithm to record sounds, and therefore saves memory space on a memory storage device such as a secure digital (SD) card or similar storage devices.

Another embodiment of the present invention provides a guitar recording and playback system further comprising a software program converting recorded audio files from an SD card or similar storage device into a playable computer format and method thereof.

These and other embodiments of the present invention are further made apparent, in the remainder of the present document, to those of ordinary skill in the art.

### BRIEF DESCRIPTION OF THE DRAWINGS

FIG. 1 illustrates an exploded view of the recording and playback device installed within a guitar, according to an embodiment of the present invention.

FIG. 2 illustrates an exploded view of the recording and playback device installed within a guitar, according to an embodiment of the present invention.

FIG. 3 illustrates an exploded view of the recording and playback device installed within a guitar, according to an embodiment of the present invention.

FIG. 4 illustrates an exploded view of the recording and playback device installed within a guitar, according to an embodiment of the present invention.

FIG. 5 illustrates the circuit diagram using a high compression and high fidelity compression algorithm to record sounds in the recording device, according to an embodiment of the present invention.

FIG. 6 illustrates a user interface, including recording and playback modes of recorded sounds from the guitar, according to an embodiment of the present invention.

FIG. 7 illustrates a user interface, including recording and playback modes of recorded sounds from the guitar, according to an embodiment of the present invention.

FIG. 8 illustrates a flow chart of an embodiment of the mechanism for recording and playback using the device in the present invention.

### DETAILED DESCRIPTION OF THE INVENTION

The description above and below and the drawings of the present invention focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention.

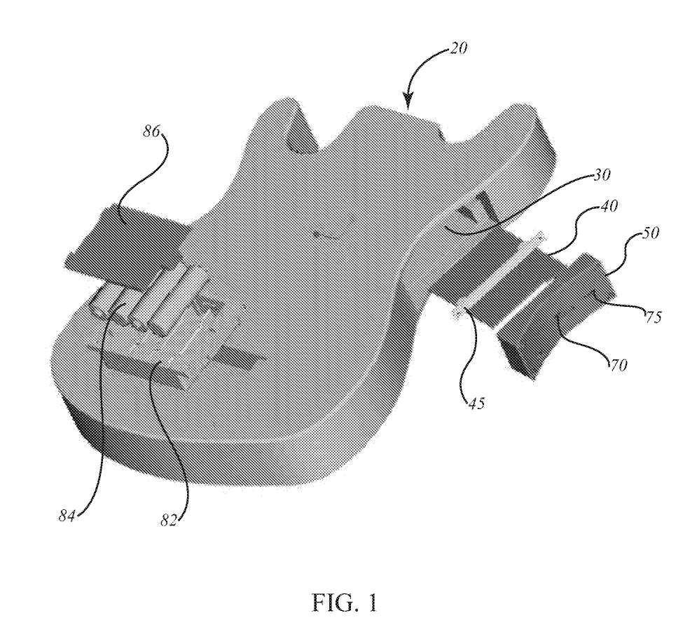

FIG. 1 illustrates a recording and playback device installed within an instrument according to an embodiment of the present invention. For purposes of illustration, the device is shown with a functioning electric guitar, though the device is not limited to guitars. An opening or cavity 30 is manufactured within a body 20 of the guitar. Within the cavity 30 is inserted the recording and playback center, comprised of a printed circuit board 40 and a user interface 50. A metal bracket 45 mounts the user interface panel 50 and circuit board 40 to the body 20. The user interface panel 50 has a playback/record button 75 and a SD card slot 70 on its face. In the back of the body 20 is the battery system 80. The battery system 80 is a compartment for batteries for the device, comprised of a casing 82 inserted into the body 20, a set of batteries 84, and a cover 86. The entire device is installed to be discrete within the guitar body 20, lightweight and user friendly. The construction of the device its compact nature provides for a very convenient way to record and playback audio without the need for extraneous connections and equipment.

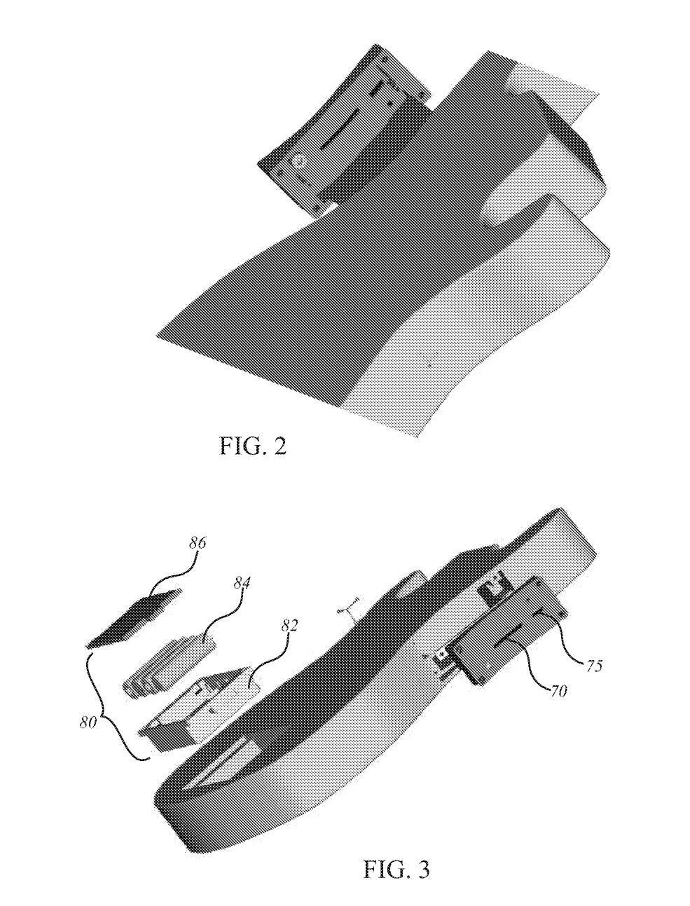

The opening or cavity 30 is a recessed hole in the side of the body 20 of the instrument, as shown in FIG. 1. It contains a slot into which the circuit board 40 can be securely inserted. A metal bracket 45 is fastened to the cavity 30 and holds the circuit board 40 in place. In addition to the slot for the circuit board 40, the cavity 30 also provides a slot for the user interface panel 50. The user interface panel 50 fastens to the circuit board 40. Additional views of how the circuit board 40 and user interface panel 50 can be inserted into the cavity 30 are shown in FIGS. 2-3. In an embodiment, the cavity 30 is located at the point of deepest curvature of the body 20 of the instrument, in order to provide a way to play the instrument without any obstruction.

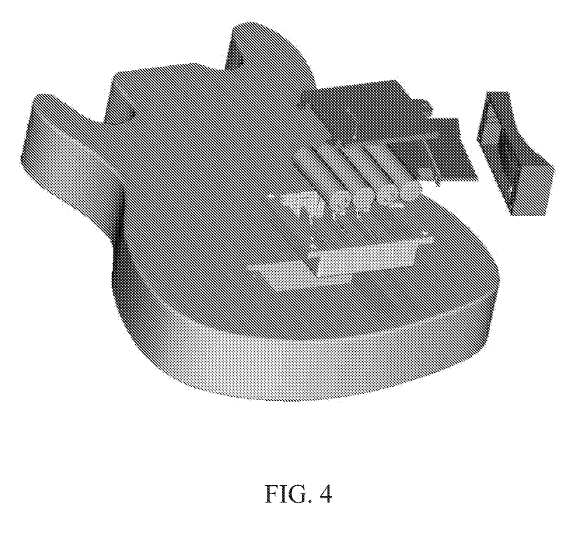

FIG. 4 illustrates the battery system according to an embodiment of the present invention. The battery system is a power supply that connects to the device. A casing 82 is provided for holding the batteries 84. The casing 82 is situated within another cavity of the body of the guitar 20, and within which the set of batteries 84 rest. A cover 86 for facilitating replacement of batteries 84 encases the battery system 80 and rests flush with the surface of the guitar body 20.

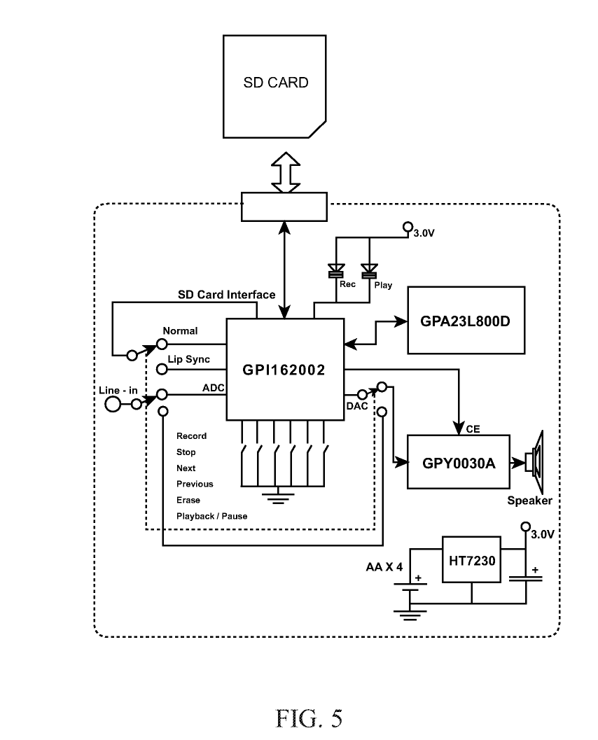

FIG. 5 illustrates a configuration of the circuit board module 40 used according to an embodiment of the present invention. The circuit board 40 enables the recording and playback of the recording device, and uses a recording algorithm to enable clear, high fidelity compression of recording. This allows for usage with conventional memory storage devices, and further saves memory storage space on such storage devices. The algorithm of the present invention is a non-MP3 (MPEG-1 Audio Layer 3) algorithm. One embodiment of the present invention is an algorithm based on Code Excited Linear Prediction (CELP). CELP is a lossy compression method using a noise-weighting technique wherein the residual noise is not significantly audible. As such, the algorithm according to an embodiment of the present invention provides for a clear audio recording. Before being sent to the guitar amplifier, the signal is diverted into the memory storage device. There are to ways to play the recordings, either through the output jack to the amplifier, or playing through a built-in speaker at the bottom of the guitar.

Included within the circuit board module 40 are components for enabling recording and playback. This includes a 16-bit LCD controller, which interfaces with a memory storage device, such as the non-volatile flash memory of an SD card; an audio driver connected to the guitar speaker; and an 8M-bit mask ROM. Functions are included that allow the user to record, stop recording, skip to the next recording track, skip to the previous recording track, erase a recording, and play back or pause a recording. FIG. 5 further illustrates the functioning of the recording module. A high compression algorithm to record the sounds from the guitar is used and results in a savings in memory space on the SD card. The recording module recognizes a sound file and removes extraneous distortion to play back a clear quality recording.

In a further embodiment, an in line jack is provided for a microphone to allow for recording of sounds exterior to the instrument including voice or singing. The additional sounds or voice can be played back along with the audio recording of the instrument. Such microphone and recording allows for a person to sing along with the playing or playback of the instrument. In an embodiment, the in line jack is located on the interface panel 50.

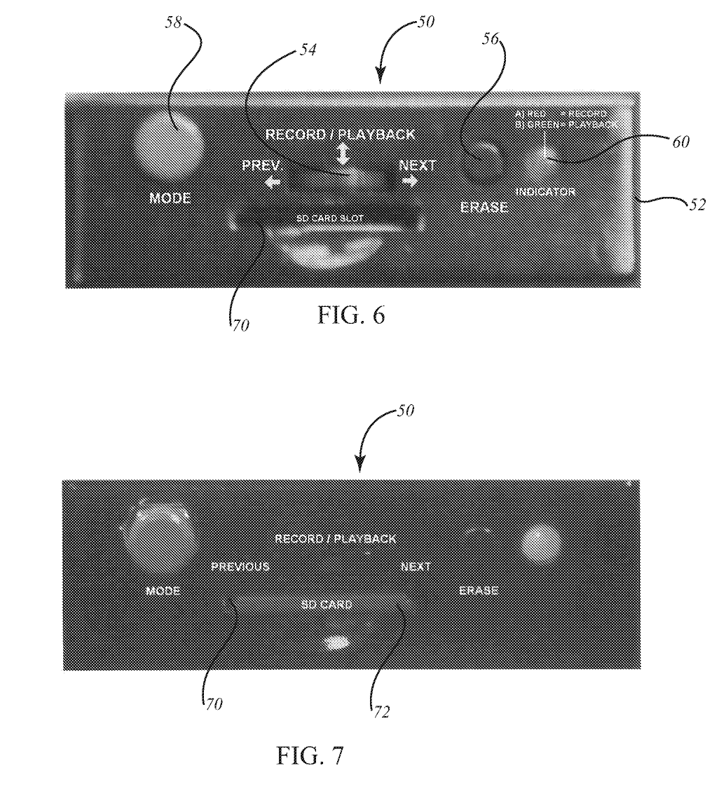

FIGS. 6-7 illustrate a user interface panel 50 which the user manipulates to engage recording or playback of the audio. The user interface panel 50 comprises a front panel 52 which houses the components; a three-dimensional button 54 with states for record/playback, next track and previous track; an erase button 56; a mode button 58 for switching between record and playback modes; an indicator light 60; an SD card slot 70; and an SD card 72 inserted into the SD card slot 70. Although an SD card is used in the preferred embodiment, any memory storage device may be used. The user interface panel 50 is connected to the circuit board module 40, and all of the elements of the user interface correspond to functions provided by the circuit board 40. The three-dimensional button 54 may be in the form of any button that allows switching between the three different states of Previous, Record/Playback, and Next. The mode button 58 toggles between Record and Playback modes. The indicator light 60 displays the current mode. For example, when the light is red, the current mode is Record. When the light is green, the current mode is Playback.

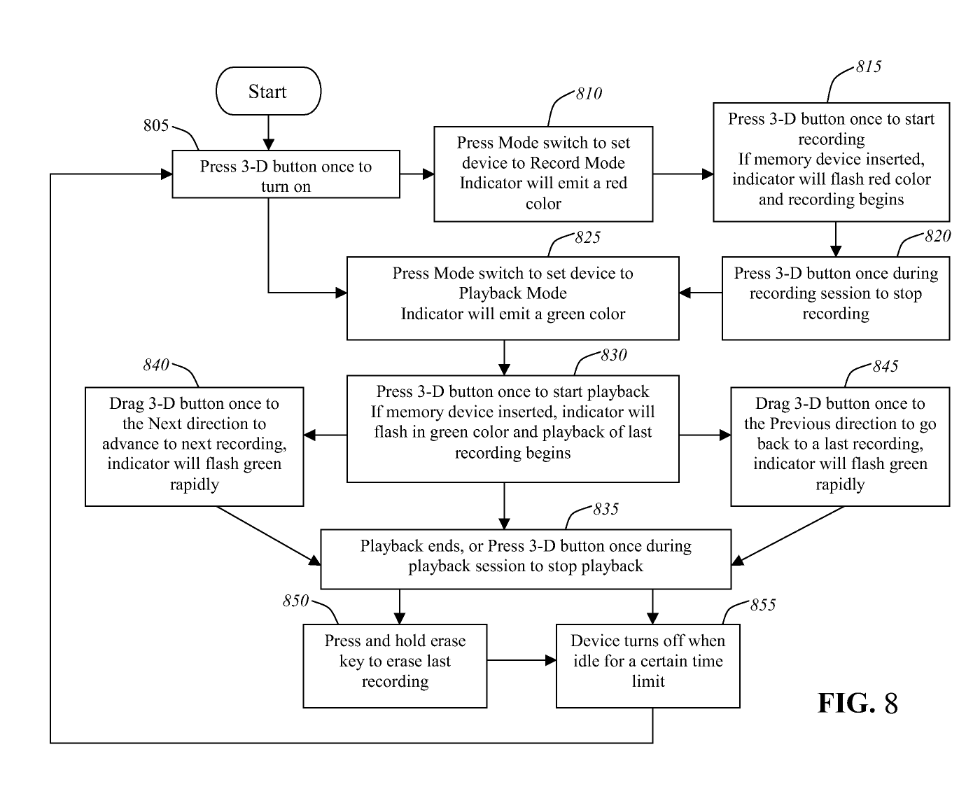

FIG. 8 illustrates the steps for recording and playback using the user interface of FIGS. 6-7. These steps are described according to an embodiment of the present invention. The order of steps are not limited to the order described but may take on varying alternatives depending on what the user intends. To turn the device on, press the three-dimensional button once 805. In order to record, press the Mode Switch to the Record Mode 810. The indicator light will emit a red color, and the Mode Switch will be in a protruded position. To begin recording, press the three-dimensional button once to start recording 815. The indicator will start to flash in a red color intermittently. To stop recording, press the three-dimensional button once during the recording session to stop recording 820. If there is no SD card inserted into the device, the device will ignore the inputs from the three-dimensional button or the erase key.

In order to playback a recording/song, press the Mode Switch to the Playback mode 825. The indicator will emit a green color, and the Mode Switch will be in a rest position. To begin playback, press the three-dimensional button once to playback the last audio/song recorded 830. The indicator will start flashing a green color intermittently. To stop playback, press the three-dimensional button once during playback 835. To jump to the next audio/song recording, drag the three-dimensional button once to the next direction during the playback 840. The indicator will flash in green rapidly. To go back to a previous audio/song recording, drag the three-dimensional button once to the previous direction during the playback 845. The indicator will flash in green rapidly. To go back to a previous audio/song recording, drag the three-dimensional button once to the previous direction during the playback 845. The indicator will flash in green rapidly. Again, during each playback, to stop playback, press the three-dimensional button once 835. When no SD card is inserted into the device, the device will ignore the inputs from the three-dimensional button or the erase key.

In order to erase a recording, press and hold the erase key in playback mode after an audio/song is played 850. The device will turn off automatically if it idles for a predetermined time limit 855, for example three minutes. To turn the device back on, press the three-dimensional button once 805.

The memory data storage device is not limited to an SD card, but can be any non-volatile memory such as a flash memory card, a USB flash memory drive, or a Smart card. In addition, to a memory data storage device, the device may incorporate other media players by being compatible with use of portable digital media players such as an MP3 player or Apple®'s iPod® player wherein the instrument itself would have a holding/carrying place for such players.

The present invention further comprises a software application program for taking the audio file saved from the memory storage device and converting it into a format that is playable on a computer system. As shown in the Appendix, the installation of the software is described detailing the operating steps to follow for converting the audio file recording from the SD card into a playable format on a computer system.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments of the foregoing description.

What is claimed is:

1. A device for recording and playback of audio from a musical instrument, embedded in said musical instrument, said musical instrument having a body, the device comprising:
a cavity manufactured within said body;
a printed circuit board to enable recording and playback, placed in said cavity;
a user interface panel, connected to said printed circuit board in said cavity, for controlling the recording and playback functions of said embedded recording device;
a mounting bracket for mounting said printed circuit board to said body;
a playback/record button for a user to play back and record audio, fitted in said user interface;
a recording algorithm for high-fidelity compression of recordings, programmed into said printed circuit board; and
a power supply for the device.

2. The device of claim 1, wherein said device includes an indicator light for indicating the recording or playback status of the device, fitted in said user interface.

3. The device of claim 1, wherein said device includes an output jack for playback through an external device or headphones, fitted in said user interface.

4. The device of claim 1, wherein said device includes a speaker for playback of recordings, built into the bottom of the guitar.

5. The device of claim 1, wherein said printed circuit board includes an audio card for processing and playing back audio.

6. The device of claim 1, wherein said recording algorithm is based on Code Excited Linear Prediction (CELP).

7. The device of claim 1, wherein said device includes a slot for a memory storage device to be inserted, embedded in said user interface.

8. The device of claim 7, wherein said slot for a memory storage device is formatted for a secure digital (SD) card to be inserted and used as a memory storage device.

9. The device of claim 7, further comprising a three-dimensional playback/record button for a user to play back and record audio, fitted in said user interface.

10. The device of claim 1, wherein said power supply for the device includes a battery system and a compartment for the batteries.

11. The device of claim 1, wherein said device includes a connection to a portable digital media player to be used as a memory storage device.

12. A method for recording and playback of audio from a musical instrument having an embedded recording device inside of a body of said musical instrument; a user interface panel fitted in the shape of a curvature of the musical instrument and connected to a printed circuit board inside the body for controlling recording and playback functions of said embedded recording device; and a recording algorithm for high-fidelity compression of recordings, programmed into said printed circuit board; said method comprising:
recording audio from said musical instrument through said recording device onto a memory storage device;
playing back said audio through said recording device; and
converting said audio into a compressed format which can be used by a computer system.

13. The method of claim 12, wherein said recording device includes an indicator light for indicating the recording or playback status of the device.

14. The method of claim 12, wherein said recording device includes an output jack for playback of said audio through an external device or headphones.

15. The method of claim 12, wherein said recording device includes a speaker for playback of said audio.

16. The method of claim 12, wherein said recording device includes an audio card for processing and playing back said audio.

17. The method of claim 12, wherein said converting is based on Code Excited Linear Prediction (CELP).

18. The method of claim 12, wherein said recording device includes a slot for said memory storage device to be inserted.

19. The method of claim 18, wherein said slot for said memory storage device is formatted for a secure digital (SD) card to be inserted and used.

20. A device for recording and playback of audio from a guitar, embedded in said guitar, the device comprising:
a cavity manufactured within the body of said guitar;
a printed circuit board to enable recording and playback, placed in said cavity;
a user interface panel fitted in the shape of the curvature of the guitar, connected to said printed circuit board in said cavity, for controlling the recording and playback functions of said embedded recording device;
a metal mounting bracket for mounting said printed circuit board to said body of stringed instrument;
a three-dimensional playback/record button for a user to play back and record audio, fitted in said user interface;
an output jack for playback through an external device or headphones, fitted in said user interface;
a speaker for playback of recordings, built into the bottom of the guitar;
a slot for a secure digital (SD) card to be inserted, embedded in said user interface;
a recording algorithm for high-fidelity compression of recordings, programmed in said printed circuit board, based on Code Excited Linear Prediction (CELP); and
a battery compartment for providing power to the device.
